(19) United States
(12) Patent Application Publication
(10) Pub. No.: US 2015/0201413 A1
(43) Pub. Date: Jul. 16, 2015

(54) WIRELESS LOCAL AREA NETWORK SYSTEM AND METHOD OF DRIVING THE SAME

(71) Applicants: Sang-Ho SEO, Gyeonggi-do (KR); Jun-Ho Huh, Gyeonggi-do (KR); Kee-Moon Chun, Gyeonggi-do (KR)

(72) Inventors: Sang-Ho SEO, Gyeonggi-do (KR); Jun-Ho Huh, Gyeonggi-do (KR); Kee-Moon Chun, Gyeonggi-do (KR)

(21) Appl. No.: 14/524,549

(22) Filed: Oct. 27, 2014

(30) Foreign Application Priority Data
Jan. 13, 2014 (KR) 10-2014-0004155

(51) Int. Cl. H04W 72/04; H04L 5/00

(52) U.S. Cl. CPC H04W 72/0446; H04L 5/0055; H04W 84/12

(57) ABSTRACT

A Wireless Local Area Network (WLAN) system and method are provided. The WLAN system includes a first station configured to transmit a first Request To Send (RTS) frame through a wireless channel, and a second station configured to determine whether the wireless channel is in a busy state after receiving the first RTS frame, when the wireless channel is in a busy state, transmit a first Clear To Send (CTS) frame, and after a Point Coordination Function Interframe Space (PIFS) time, transmit a second CTS frame corresponding to the first RTS frame.

### PRIORITY

This application claims priority under 35 U.S.C. §119(a) to a Korean Patent Application filed on Jan. 13, 2014 in the Korean Intellectual Property Office and assigned Serial No. 10-2014-0004155, the entire contents of which are incorporated herein by reference.

### BACKGROUND

1. Field of the Invention

The present invention relates generally to a Wireless Local Area Network (WLAN) system, and more particularly, to a WLAN system including a station which transmits a Request To Send (RTS) signal and a station capable of operating as an Access Point (AP) which transmits a Clear To Send (CTS) signal, and a method of driving the same.

2. Description of Related Art

Various Wireless Local Area Network technologies are being developed together with developments of recent information communication technologies. Among them, the Wireless Local Area Network (hereinafter, it is referred to as WLAN) is a technology which can make a connection to a super-high-speed Internet by wireless in homes, businesses, or a specific service providing area using a portable terminal such as a Personal Digital Assistant (PDA), a laptop computer, a Portable Multimedia Player (PMP), or the like, based on wireless frequency technology.

A WLAN station according to a Medium Access Control (MAC) protocol of the WLAN basically operates as a Carrier Sense Multiple Access with Collision Avoidance (CSMA/CA) method.

For example, the WLAN station according to the MAC protocol senses a channel state. After sensing the channel state, when the channel state is determined as an idle state under a specific condition, the WLAN station acquires a corresponding channel and transmits data. That is, the WLAN station performs a channel access through a carrier sensing operation. Therefore, two issues can occur from the viewpoint of a MAC protocol.

First, if each of two WLAN stations different from each other fails to sense a signal from each other, there is a hidden node issue, where a collision in a shared channel may occur. Second, there is a near-far issue if a transmission signal of a WLAN station near an AP offsets a degradation signal of a WLAN station relatively far away from the AP. Because of this, an effect which reduces channel access chances unintentionally, that is, a capture effect, can occur in the WLAN station which transmits the degradation signal. Due to the above two issues, network throughput of a WLAN system is reduced and network unfairness can occur.

Further, the above two issues frequently occur as the number of stations in the network increases, and they may be one of solution objects of a High Efficiency Wireless Local Area Network (HEW) when a standardized group is in progress.

### SUMMARY

The present invention has been made to address the above-mentioned problems and disadvantages, and to provide at least the advantages described below. Accordingly, an aspect of the present invention provides a wireless local area network (WLAN) system which can avoid a capture effect capable of occurring in a request to send (RTS)-clear to send (CTS) frame exchange method.

In accordance with one aspect of the present invention, a Wireless Local Area Network (WLAN) system is provided. The WLAN system includes a first station configured to transmit a first Request To Send (RTS) frame through a wireless channel; and a second station configured to determine whether the wireless channel is in a busy state after receiving the first RTS frame, when the wireless channel is in a busy state, transmit a first Clear To Send (CTS) frame, and after a Point Coordination Function Interframe Space (PIFS) time, transmit a second CTS frame corresponding to the first RTS frame.

In accordance with another aspect of the present invention, a method of a Wireless Local Area Network (WLAN) system is provided. The method includes transmitting a first Request To Send (RTS) frame through a wireless channel by a first station; determining whether the wireless channel is in a busy state; transmitting a first Clear To Send (CTS) frame corresponding to the first RTS frame by a second station when the wireless channel is in a busy state; and after a Point Coordination Function Interframe Space (PIFS) time, transmitting a second CTS frame by the second station.

In accordance with another aspect of the present invention, a method of driving a station capable of operating as an Access Point (AP) is provided. The method includes receiving a first Request To Send (RTS) frame through a wireless channel; determining whether the wireless channel is in a busy state; transmitting a first Clear To Send (CTS) frame corresponding to the first RTS frame when the wireless channel is in a busy state; and after a Point Coordination Function Interframe Space (PIFS) time, transmitting a second CTS frame.

### BRIEF DESCRIPTION OF THE DRAWINGS

The foregoing and other aspects, features, and advantages of the present invention will be more apparent from the following description, taken in conjunction with the accompanying drawings, in which:

FIG. 1 illustrates a conventional Wireless Local Area Network (WLAN) system;

FIG. 2 is a diagram illustrating a conventional RTS-CTS frame exchange method;

FIG. 3 is a timing diagram illustrating an operation of the WLAN system shown in FIG. 1;

FIG. 4 illustrates a WLAN system including first and second WLAN stations;

FIG. 5 is a timing diagram illustrating an operation of the WLAN shown in FIG. 4;

FIG. 6 is a timing diagram illustrating an operation of a WLAN system using a special CTS method to address a hidden node issue;

FIG. 7 is a block diagram of a WLAN system including first to third WLAN stations;

FIG. 8 is a timing diagram illustrating unfairness of the WLAN system shown in FIG. 7;

FIG. 9 is a timing diagram illustrating an issue of the WLAN system shown in FIG. 7;

FIG. 10 is a block diagram illustrating a WLAN system according to an embodiment of the present invention;

FIG. 11 is a timing diagram illustrating timing of the WLAN system shown in FIG. 10;

FIG. 12 is a graph illustrating a simulation result for verifying an effect of the WLAN system according to an embodiment of the present invention;

FIG. 13 is a flowchart illustrating a method of driving a WLAN system according to an embodiment of the present invention;

FIG. 14 is a flowchart illustrating a method of driving a station which operates as an Access Point according to an embodiment of the present invention;

FIG. 15 is a block diagram of a computer system according to an embodiment of the present invention; and

FIG. 16 is a block diagram of a computer system according to an embodiment of the present invention.

### DETAILED DESCRIPTION OF EMBODIMENTS OF THE PRESENT INVENTION

Embodiments of the present invention are described below in sufficient detail to enable those of ordinary skill in the art to embody and practice the present invention. It is important to understand that the present invention may be embodied in many alternate forms and should not be construed as limited to the embodiments set forth herein.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements. Other words used to describe relationships between elements should be interpreted in a like fashion (i.e., “between” versus “directly between,” “adjacent” versus “directly adjacent,” etc.).

It will be understood that, although the terms first, second, A, B, etc. may be used herein in reference to elements of the invention, such elements should not be construed as limited by these terms. For example, a first element may be referred to as a second element, and a second element may be referred to as a first element, without departing from the scope of the present invention. Herein, the term “and/or” includes any and all combinations of one or more referents.

Spatially relative terms, such as “beneath,” “below,” “lower,” “above,” “upper” and the like, may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein to describe embodiments of the invention is not intended to limit the scope of the invention. The articles “a,” “an,” and “the” are singular in that they have a single referent, however the use of the singular form in the present document should not preclude the presence of more than one referent. In other words, elements of the invention referred to in the singular may number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

Embodiments are described herein with reference to cross-sectional illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein are to be interpreted as is customary in the art to which this invention belongs. It will be further understood that terms in common usage should also be interpreted as is customary in the relevant art and not in an idealized or overly formal sense unless expressly so defined herein.

Embodiments of the present inventive concept will be described below with reference to the attached drawings, in which like reference characters refer to the same parts throughout the different views. The drawings are not necessarily to scale, with emphasis instead being placed upon illustrating the principles of the present invention.

A station according to an embodiment of the present invention may include both a Wireless Local Area Network (WLAN) station and an Access Point (AP) station.

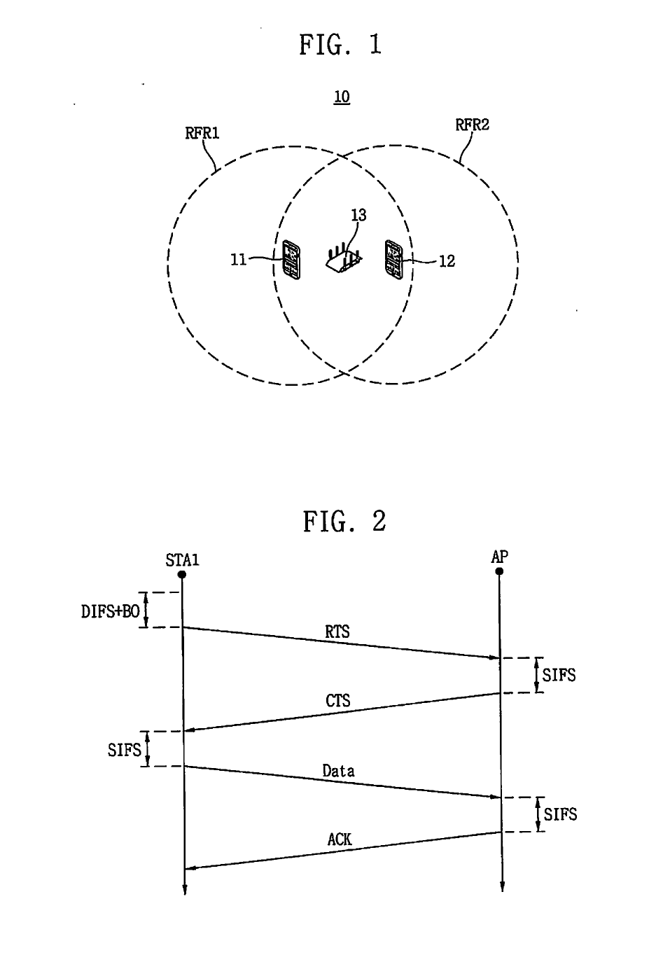

FIG. 1 illustrates a conventional Wireless Local Area Network (WLAN) system.

Referring to FIG. 1, a conventional WLAN system 10 includes a first station 11 and a second station 12, where a third station 13 operates as an AP. Each of the first station 11 and the second station 12 may perform data communication through the third station 13.

Each of the first station 11 and the second station 12 includes a WLAN station which operates according to a WLAN protocol. Also, the third station 13 includes an AP station, or operates as the AP station using tethering.

The third station 13 is connected to each of the first station 11 and the second station 12 through a wireless channel according to a WLAN protocol (that is, IEEE 802.11).

The first station 11 has a first radio frequency range (RFR1). The second station 12 has a second radio frequency range (RFR2). The radio frequency range is determined according to frequencies and surrounding conditions. The third station 13 is located in a common area of each of the first and second radio frequency ranges RFR1 and RFR2. The first station 11 is located in the second radio frequency range RFR2. The second station 12 is located in the first radio frequency range RFR1.

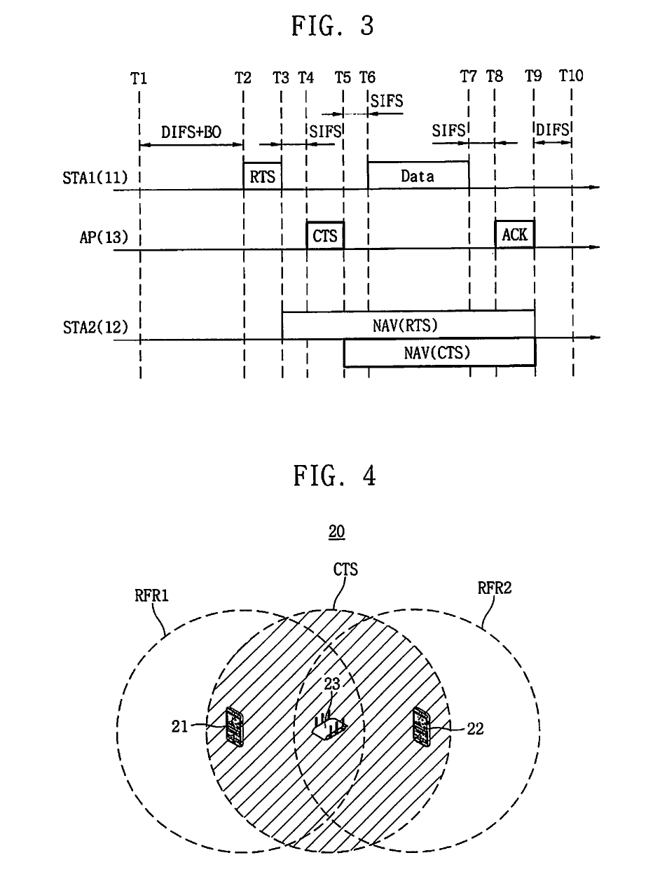

The WLAN system 10 uses an RTS-CTS frame exchange method to secure transmission chances of each of the contending first station 11 and the second station 12. The RTS-CTS frame exchange method will be described with reference to FIGS. 2 and 3.

FIG. 2 is a diagram illustrating a conventional RTS-CTS frame exchange method.

Referring to FIGS. 1 and 2, the first station 11 (e.g. STA1), after waiting a Distributed Coordination Function Interframe Space (DIFS) time and a Backoff (BO) time, transmits an RTS frame which is a transmission request signal to the third station 13 (e.g. AP). That is, the first station 11, during the BO time, performs a count-down operation by a backoff counter.

The DIFS time means a minimum time that each of the stations has to wait from just after any station uses an AP station last when each of the stations in a contention-based service in Institute of Electrical and Electronics Engineers (IEEE) 802.11, which is a WLAN standard, tries to access the AP station. That is, the DIFS time is one of Interframe Spaces (IFSs) which are specified in the WLAN standard, and means the minimum time for performing a backoff operation.

The third station 13 transmits a CTS frame which is a transmission allowance signal after waiting a Short Interframe Space (SIFS) time.

The first station 11 waits during the SIFS time after receiving the CTS frame. After this, the first station 11 transmits a data frame. The third station 13 waits during the SIFS time after receiving the data frame. After this, the third station 13 transmits an Acknowledgement (ACK) frame which is a data frame reception completion signal. The first station 11 receives the ACK frame.

In the WLAN protocol, the SIFS time is a minimum time which has to wait between frames according to the WLAN protocol. For example, the SIFS time may be defined as a time interval between the data frame and the ACK frame or the RTS frame and the CTS frame.

The RTS frame and the CTS frame are control frames having a minimum length unlike the data frame. When one of the first station 11 and the second station 12 receives the CTS frame, it may anticipate channel occupancy even when not sensing a hidden node directly.

Since an additional time of a transmission time of the RTS frame and the CTS frame plus double SIFS time is included, the RTS-CTS frame exchange method may reduce network throughput. However, when there is a station like a hidden node, since a collision is previously avoided, the network throughput may be increased.

Timing of the WLAN system 10 using the RTS-CTS frame exchange method will be described with reference to FIG. 3.

FIG. 3 is a timing diagram illustrating an operation of the WLAN system shown in FIG. 1.

Referring to FIGS. 1 and 3, the WLAN system 10 uses the RTS-CTS frame exchange method.

Time T1 to time T2 corresponds to a DIFS time and a BO time. The first station 11 waits during the DIFS time and the BO time. During the BO time, the first station 11 performs a count-down operation by a backoff counter.

At time T2, when the count-down operation by the first station 11 is completed, the first station 11 transmits an RTS frame through a wireless channel.

When the second station 12 receives the RTS frame, the second station 12 sets a Network Allocation Vector (NAV) value such that the second station 12 does not access the third station 13 from time T3 to time T9 in order to avoid a collision in the wireless channel. If there is a collision in the wireless channel, data communication between the first station 11 and the third station 13 may not be performed normally. Accordingly, the network throughput of the WLAN system 10 may be reduced.

The NAV means time information that the third station 13 is using in IEEE 802.11, which is a WLAN standard. For example, the second station 12 which wants to transmit a data frame to the third station 13 may set an anticipated standby time as the NAV value.

Time T3 to time T4 corresponds to an SIFS time. In order to comply with the WLAN protocol, the third station 13 waits during the SIFS time.

At time T4, the third station 13 transmits a CTS frame.

When the second station 12 receives the CTS frame, the second station 12 sets the NAV value not to access the third station 13 from time T5 to time T9.

From time T6 to time T7, the first station 11 transmits a data frame. The third station 13 may receive the data frame.

From time T7 to time T8 corresponds to an SIFS time, at which time the third station 13 waits.

At time T8, the third station 13 transmits an ACK frame.

Time T9 to time T10 corresponds to the DIFS time.

The first station 11, the second station 12, and the third station 13 wait from time T9 to time T10 (that is, the DIFS time).

FIG. 4 illustrates a WLAN system including a first WLAN station 21 and a second WLAN station 22.

Referring to FIG. 4, a WLAN system 20 includes a first station 21 and a second station 22, where a third station 23 operates as an AP. Each of the first station 21 and the second station 22 perform data communication through the third station 23. The third station 23 is connected to each of the first station 21 and the second station 22 through a wireless channel according to a WLAN protocol. The first station 21 has a first radio frequency range (RFR1). The second station 22 has a second radio frequency range (RFR2). The radio frequency range is determined according to frequencies and surrounding conditions.

The third station 23 is located in a common area of each of the first radio frequency range RFR1 and second radio frequency range RFR2. The first station 21 is located outside the second radio frequency range RFR2. The second station 22 is located outside the first radio frequency range RFR1.

The third station 23 receives an RTS frame from one of the first station 21 and second station 22, and transmits a CTS frame as a response thereto.

In order to address a hidden node issue, when using an RTS-CTS frame exchange method, a capture effect may occur in the WLAN system 20.

For example, the first station 21 and the second station 22 are hidden nodes to each other. Since each of the first station 21 and the second station 22 do not exist within a mutual radio frequency range, it may not receive a counterpart signal. That is, based on the first station 21, the second station 22 is located in a hidden node. Accordingly, even if each of the first station 21 and the second station 22 communicates with the third station 23, it may not receive a counterpart signal.

In this case, each of the first station 21 and the second station 22 may try to access the third station 23 simultaneously. Therefore, network throughput of the WLAN system 20 may be reduced.

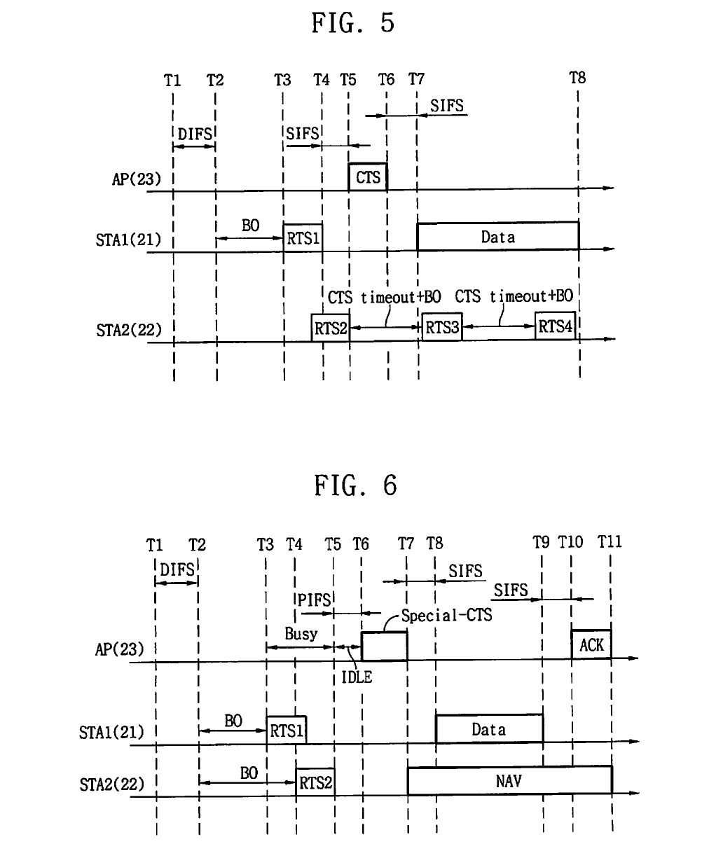

FIG. 5 is a timing diagram illustrating an operation of the WLAN shown in FIG. 4.

Referring to FIGS. 4 and 5, the first station 21 waits from time T1 to time T2 (that is, a DIFS time).

The first station 21 waits from time T2 to time T3 (that is, a BO time).

At time T3, the first station 21 transmits an RTS1 frame. The third station 23 receives the RTS1 frame. Since the first station 21 and the second station 22 are located in a hidden node from each other, the second station 22 may not receive a signal of the first station 21.

Time T4 to time T5 corresponds to an SIFS time. The wireless channel holds an idle state during the SIFS time according to a WLAN protocol. The third station 23 confirms a state of the wireless channel during the SIFS time. When the state of the wireless channel is in an idle state, at time T5, the third station 23 transmits a CTS frame.

However, from time T4 to time T5 (that is, the SIFS time), when the second station 22 transmits an RTS2 frame, the second station 22 may not receive the CTS frame sent from the third station 23.

At time T5, the third station 23 transmits the CTS frame. The first station 21 receives the CTS frame. However, when a capture effect occurs in the wireless channel, the second station 22 may not receive the CTS frame.

Time T6 to time T7 corresponds to the SIFS time. The first station 21 waits during the SIFS time.

From time T7 to time T8, the first station 21 transmits a data frame. The third station 23 receives the data frame.

Meanwhile, the second station 22 failed to receive the CTS frame from the third station 23 and transmits an RTS3 frame, after waiting the SIFS time and a BO time, in order to communicate with the third station 23. Continuously, the second station 22 failed to receive the CTS frame and transmits an RTS4 frame, after waiting the SIFS time and a BO time.

Since the BO value is exponentially increased as retransmission is repeated, the second station 22 may not have a chance to access a channel for the exponentially increased time. Further, due to the repeated retransmission of the second station 22, another station near the second station 22 may experience a situation where it fails to even attempt a transmission. Accordingly, network throughput and fairness of the WLAN system 20 may be reduced.

To address this issue, the WLAN system 20 uses a special CTS method. The WLAN system 20 using the special CTS method will be described with reference to FIG. 6.

FIG. 6 is a timing diagram illustrating an operation of a WLAN system using a special CTS method to address a hidden node issue.

Referring to FIGS. 4 and 6, in order to address a hidden node issue, the WLAN system 20 uses a special CTS frame which does not comply with a WLAN protocol. The third station 23 transmits the special CTS frame to the second station 22. The second station 22 receives the special CTS frame, and sets a NAV value using the special CTS frame.

The first station 21 waits from time T1 to time T2 (that is, a DIFS time).

The first station 21 waits from time T2 to time T3 (that is, a BO time).

At time T3, the first station 21 transmits an RTS1 frame to the third station 23.

At time T4, since the first station 21 and the second station 22 are located in a hidden node mutually, the second station 22 may not receive a signal of the first station 2l. Accordingly, the second station 22 failed to receive the RTS1 frame and transmits an RTS2 frame to the third station 23.

Time T5 to time T6 corresponds to a Point Coordination Function Interframe Space (PIFS) time. The PIFS time is shorter than the DIFS time, and longer than the SIFS time. In order to comply with the WLAN protocol, the third station 23 waits during the PIFS time.

At time T6, the third station 23 transmits a special CTS frame. Each of the first station 21 and the second station 22 receives the special CTS frame.

Time T7 to time T8 corresponds to the SIFS time. The first station 21 waits during the SIFS time.

From time T8 to time T9, the first station 21 transmits a data frame.

Meanwhile, the second station 22 which received the special CTS frame from the third station 23 may set a NAV value to not access the third station 23 from time T7 to time T11 time to avoid a collision.

At time T10, the third station 23 transmits an ACK frame after waiting the SIFS time.

The WLAN system 20 using the special CTS frame may avoid network unfairness due to a capture effect. However, since the WLAN system 20 using the special CTS frame uses a frame (that is, the special CTS frame) which does not comply with the WLAN standard, it may not be used for stations which comply with a standard.

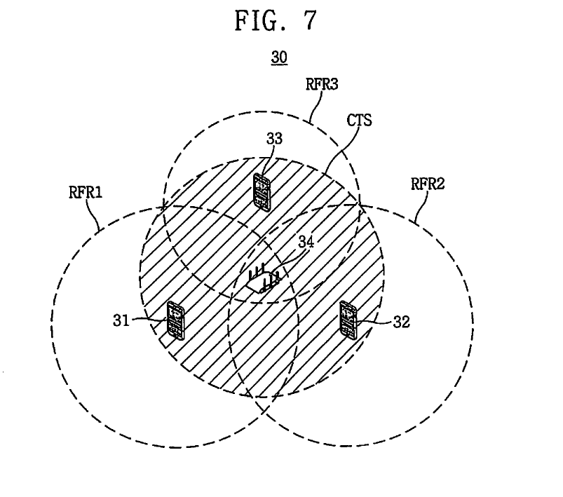

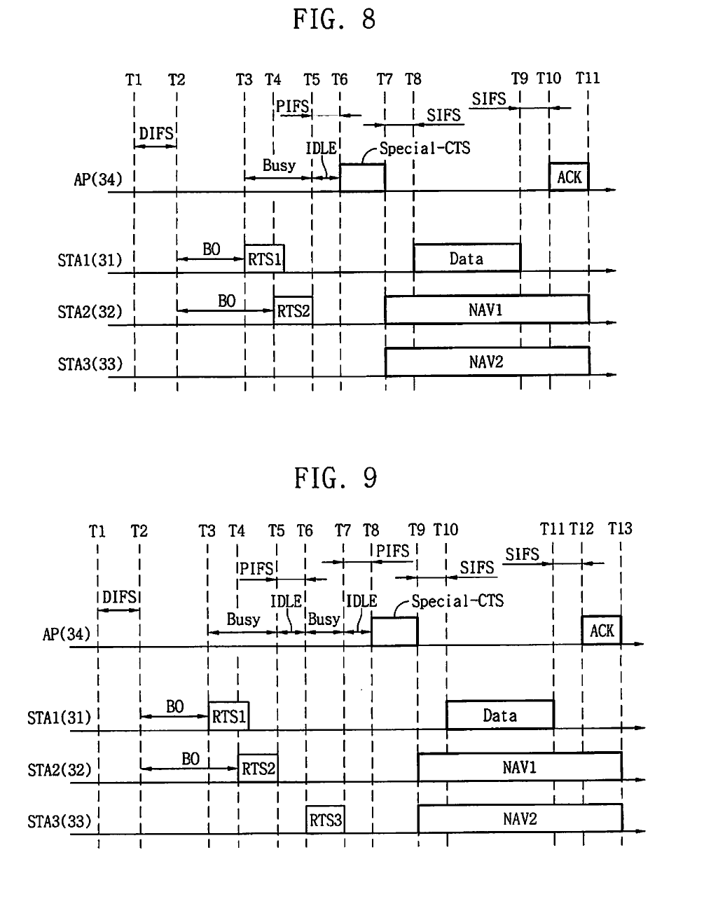

Further, the WLAN system 20 including at least three stations has unfairness. This issue will be described with reference to FIGS. 7 and 8.

When each of the at least three stations transmits an RTS frame, the WLAN system 20 using the special CTS frame may fail to receive the CTS frame for a long time. This issue will be described with reference to FIG. 9.

FIG. 7 is a block diagram of a WLAN system including three WLAN stations.

Referring to FIG. 7, a WLAN system 30 includes a first station 31, a second station 32, and a third station 33, where a fourth station 34 operates as an AP. Each of the first station 31, the second station 32, and the third station 33 performs data communication through the fourth station 34. The fourth station 34 is connected to each of the first station 31, the second stations 32, and the third station 33 through a wireless channel according to the WLAN protocol. The fourth station 34 receives an RTS frame from one of the first station 31, the second station 32, and the third station 33, and transmits a CTS or special CTS frame as a response thereto.

The first station 31 has a first radio frequency range RFR1. The second station 32 has a second radio frequency range (RFR2). The third station 33 has a third radio frequency range (RFR3). The radio frequency range is determined according to frequencies and surrounding conditions. The fourth station 34 is located in a common area of each of the first radio frequency range RFR1, the second radio frequency range RFR2, and the third radio frequency range RFR3.

The first station 31 is located outside the second radio frequency range RFR2 and the third radio frequency range RFR3. Accordingly, the first station 31 may not receive a signal from the second station 32 and the third station 33.

The second station 32 is located outside the first radio frequency range RFR1 and the third radio frequency range RFR3. Accordingly, the second station 32 may not receive a signal from the first station 31 and the third station 33.

The third station 33 is located outside the first radio frequency range RFR1 and the second radio frequency range RFR2. Accordingly, the third station 33 may not receive a signal from the first station 31 and the second station 32.

FIG. 8 is a timing diagram illustrating unfairness of the WLAN system shown in FIG. 7.

Referring to FIGS. 7 and 8, unfairness of the WLAN system 30 using a special CTS frame may occur when each of at least three stations accesses an AP station.

For example, at time T3, the first station 31 transmits an RTS1 frame. At time T4, the second station 32 transmits an RTS2 frame. The fourth station 34 waits from time T5 to time T6. At time T6, the fourth station 34 transmits a special CTS frame. The second station 32, which receives the special CTS frame, sets a NAV1 value to wait from time T7 time to time T11. The third station 33, which receives the special CTS frame, sets a NAV2 value to wait from time T7 to time T11.

In this case, the second station 32 made a request to the fourth station 34, but the third station 33 did not make a request to the fourth station 34. Accordingly, it is unfair to wait during the same time (that is, from time T7 to time T11) for the second station 32 and the third station 33. This is because the second station 32 which made a request to the fourth station 34 does not have a priority.

FIG. 9 is a timing diagram illustrating an issue of the WLAN system shown in FIG. 7.

Referring to FIGS. 7 and 9, the WLAN system 30 using the special CTS frame may fail to receive a CTS frame for a long time when each of the at least three stations transmits an RTS frame.

For example, at time T3, the first station 31 transmits an RTS1 frame. At time T4, the second station 32 transmits an RTS2 frame. The fourth station 34 waits from time T5 to time T6. At time T6, the third station 130 transmits an RTS3 frame. At time T8, the fourth station 34 transmits the special CTS frame.

The second station 32, which receives the special CTS frame, sets a NAV1 value to wait from time T9 to time T13. The third station 33, which receives the special CTS frame, sets a NAV2 value to wait from time T9 to time T13.

When the third station 33 transmits an RTS3 frame before the first station 31 receives the special CTS frame from the fourth station 34, the first station 31 waits until a wireless channel goes into an idle state during a PIFS time. Accordingly, the first station 31 may fail to receive the CTS frame after a predetermined time (that is, a CTS timeout). This may be a structural issue of a method of using the special CTS frame.

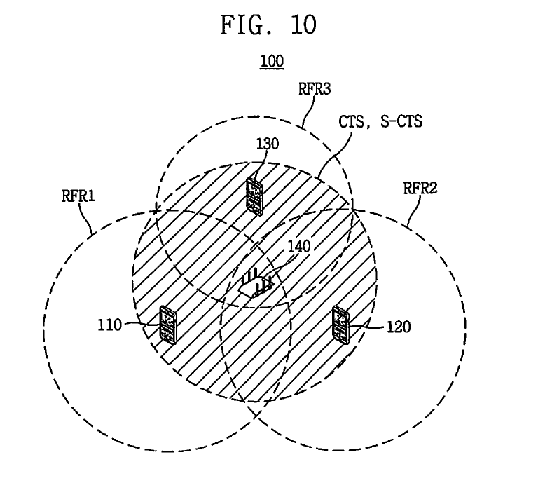

To address the above issue, the WLAN system according to an embodiment of the present invention uses a dual CTS frame (that is, CTS, Special CTS). The detailed description will be explained with reference to FIGS. 10 to 13.

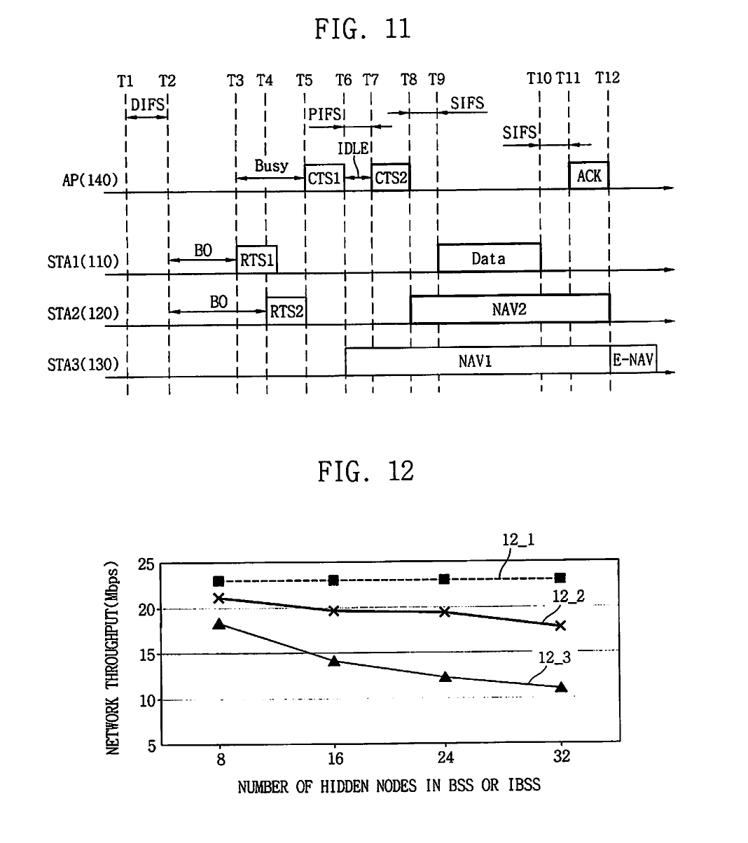

A WLAN system according to an embodiment of the present invention may offset a capture effect capable of occurring in a Request To Send (RTS)—Clear To Send (CTS) frame exchange method. The WLAN system will be described with reference to FIGS. 10 and 11.

FIG. 10 is a block diagram illustrating a WLAN system according to an embodiment of the present invention.

Referring to FIG. 10, a WLAN system 100 according to an embodiment of the present invention includes a first station 110, a second station 120, and a third station 130, where a fourth station 140 operates as an AP. Each of the first station 110, the second station 120, and the third station 130 communicates data through the fourth station 140.

The fourth station 140 is connected to each of the first station 110, the second station 120, and the third station 130 through a wireless channel according to a WLAN protocol. The fourth station 140 transmits the dual CTS frame (that is, CTS, S-CTS) having a NAV value different from each other. In an embodiment of the present invention, a smart phone or a tablet Personal Computer (PC) operates as the fourth station 140 using tethering.

The first station 110 has a first radio frequency range RFR1. The second station 120 has a second radio frequency range RFR2. The third station 130 has a third radio frequency range RFR3. The radio frequency range is determined according to frequencies and surrounding conditions. The fourth station 140 is located in a common area of each of the first radio frequency range RFR1, the second radio frequency range RFR2, and the third radio frequency range RFR3.

The first station 110 is located outside the second radio frequency range RFR1 and the third radio frequency range RFR3. Accordingly, the first station 110 may not receive a signal from the second station 120 and the third station 130.

The second station 120 is located outside the first radio frequency range RFR1 and the third radio frequency range RFR3. Accordingly, the second station 120 may not receive a signal from the first station 110 and the third station 130.

The third station 130 is located outside the first radio frequency range RFR1 and the second radio frequency range RFR2. Accordingly, the third station 130 may not receive a signal from the first station 110 and the second station 120.

For example, since each of the first station 110 and the second station 120 do not exist within a mutual radio frequency range, it may not receive a counterpart signal. That is, based on the first station 110, the second station 120 is located in a hidden node. Accordingly, even if each of the first station 110 and the second station 120 communicates with the fourth station 140, it may not receive a counterpart signal.

In this case, the first station 110 and the second station 120 may cause a hidden node issue. That is, each of the first station 110 and the second station 120 tries to access the fourth station 140 simultaneously. Therefore, network throughput of the WLAN system 100 may be reduced. To address the hidden node issue, the WLAN system 100 may use a dual CTS method. The dual CTS method will be described with reference to FIG. 11.

FIG. 11 is a timing diagram illustrating timing of the WLAN system shown in FIG. 10.

Referring to FIGS. 10 and 11, generally, the fourth station 140 receives an RTS frame, and transmits a CTS frame as a response thereto. However, when a type of a WLAN protocol of each of a plurality of stations trying to access the fourth station 140 is different from another, the fourth station 140 may retransmit the CTS frame suitably for each type.

For example, when the first station 110 supports IEEE 802.11/a and the second station 120 supports IEEE 802.11/n, the fourth station 140 transmits a CTS frame that the first station 110 supports, and after the PIFS time, transmits a CTS frame that the second station 120 supports.

A CTS1 frame includes a self-CTS (S-CTS) signal for the fourth station 140 itself which operates as an AR A CTS2 frame includes a standby signal for the first station 110. RTS1 and RTS2 frames include a transmission request signal for the fourth station 140.

From time T1 to time T2 (that is, a DIFS time), the first station 110 waits.

From time T2 to time T3 (that is, a BO time), the first station 110 waits more.

At time T3, the first station 110 transmits the RTS1 frame through a wireless channel. Therefore, the wireless channel is in a busy state.

At time T4, the second station 120 transmits the RTS2 frame through the wireless channel.

From time T3 to time T5, the fourth station 140 determines whether the wireless channel is in a busy state. When the wireless channel is in a busy state, the fourth station 140 transmits the CTS1 frame, and after the PIFS time, the fourth station 140 transmits the CTS2 frame.

When the wireless channel is not in a busy state, after an SIFS time, the fourth station 140 transmits only the CTS2 frame.

At time T5, the fourth station 140 transmits the CTS1 frame. The third station 130, which receives the CTS1 frame sets, a NAV1 value. That is, the third station 130 sets the NAV1 value to not access the fourth station 140 from time T6 to time T12. Further, the third station 130 additionally sets an extra-NAV (E-NAV) value such that the second station 120 accesses the fourth station 140. Due to a time-based protocol of the wireless channel, the second station 120 may not receive the CTS1 frame.

From time T6 to time T7 (that is, during the PIFS time), the fourth station 140 waits. At time T7, the fourth station 140 transmits the CTS2 frame. The second station 120, which receives the CTS2 frame, sets a NAV2 value. That is, the second station 120 sets the NAV2 value to not access the fourth station 140 from time T8 to time T12.

From time T8 to time T9 (that is, during the SIFS time), the fourth station 140 waits.

From time T9 to time T10, the first station 110 transmits a data frame.

At time T11, the fourth station 140, which receives the data frame, transmits an ACK frame.

FIG. 12 is a graph illustrating a simulation result for verifying an effect of the WLAN system according to an embodiment of the present invention.

Referring to FIG. 12, the horizontal coordinate (x-axis) represents the number of hidden nodes within one basic service set (BSS) or independent basic service set (IBSS), and the vertical coordinate (y-axis) represents network throughput.

A first curve 12_1 represents ideal network throughput. That is, even when the number of hidden nodes is increased, the network throughput may not be reduced completely. A second curve 12_2 represents the network throughput of the WLAN system according to an embodiment of the present invention. That is, even when the number of hidden nodes is increased, the drop of the network throughput is small. The third curve 12_3 represents network throughput of a conventional WLAN system. That is, when the number of hidden nodes is increased, the network throughput may be reduced.

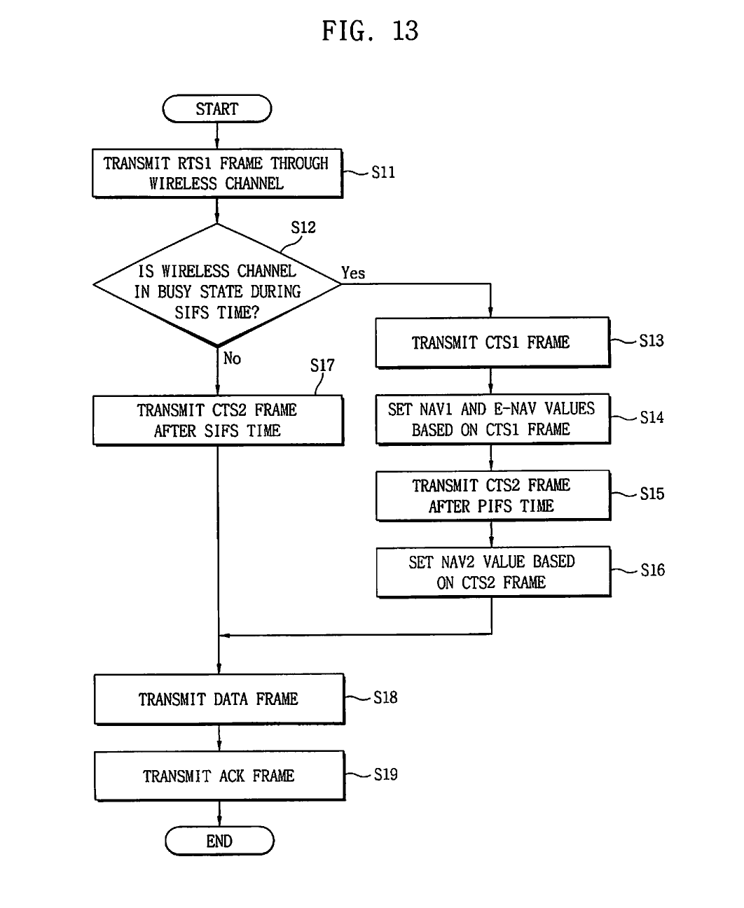

A method of driving a WLAN system according to an embodiment of the present invention will be described with reference to FIG. 13.

FIG. 13 is a flowchart illustrating a method of driving a WLAN system shown in FIG. 10.

Referring to FIGS. 10 and 13, in step S11, the first station 110 transmits an RTS1 frame through a wireless channel.

In step S12, during a SIFS time, the fourth station 140 determines whether the wireless channel is in a busy state. If the wireless channel is in a busy state, steps S13 to S16 are performed. If not, step S17 is performed. For example, during the SIFS time, when the second station 120 transmits the RTS2 frame, the wireless channel may be in a busy state.

In step S13, the fourth station 140 transmits a CTS1 frame.

In step S14, the third station 130, which receives the CTS1 frame, sets a NAV1 value. Further, the third station 130 additionally sets an E-NAV value such that the second station 120 preferentially accesses the fourth station 140. Due to a collision of the wireless channel, the second station 120 may fail to receive the CTS1 frame.

When stations which try to access the fourth station 140 around the fourth station 140, each of the stations, which receives the CTS1 frame sets, the NAV value and the E-NAV value.

In step S15, after a PIFS time, the fourth station 140 transmits a CTS2 frame.

In step S16, the second station 120, which receives the CTS2 frame, sets a NAV2 value.

If the wireless channel is not in a busy state, in step S17, the fourth station 140 transmits the CTS1 frame.

In step S18, the first station 110, which receives the CTS1 frame, transmits a data frame after the SIFS time.

In step S19, the fourth station 140, which receives the data frame, transmits an ACK frame after the SIFS time.

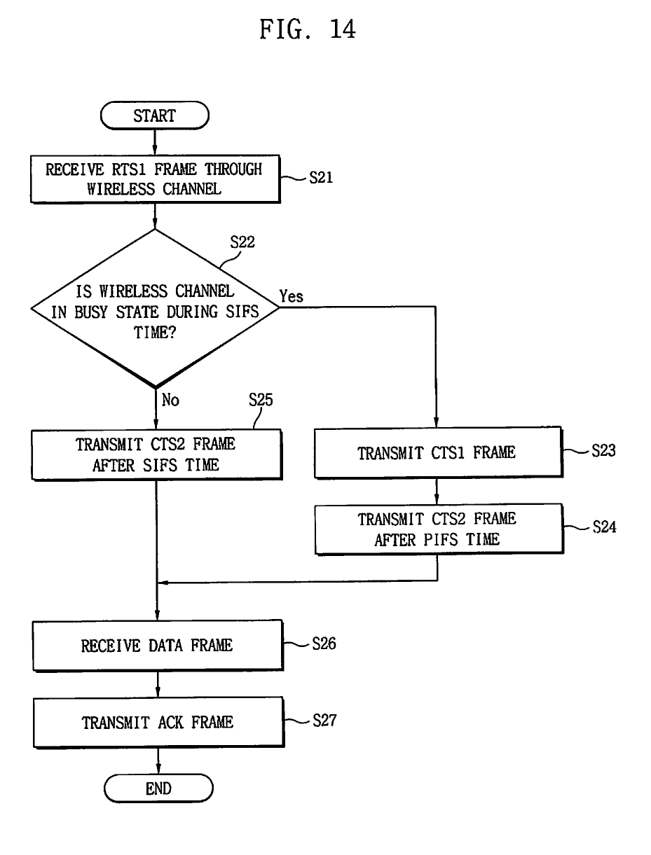

A method of driving a station according to an embodiment of the present invention may use a method similar to a dual CTS method. The method of driving the station which operates as an AP will be described with reference to FIG. 14.

FIG. 14 is a flowchart illustrating a method of driving a station which operates as an AP according to another embodiment of the present invention.

Referring to FIGS. 10 and 14, in step S21, the fourth station 140 receives an RTS1 frame through a wireless channel.

In step S22, during an SIFS time, the fourth station 140 determines whether the wireless channel is in a busy state. If the wireless channel is in a busy state, step S23 and step S24 are performed. If not, step S25 is performed. For example, during the SIFS time, when the second station 120 transmits an RTS2 frame, the wireless channel may be in a busy state.

In step S23, the fourth station 140 transmits the CTS1 frame.

In step S24, after a PIFS time, the fourth station 140 transmits a CTS2 frame.

In step S25, if the wireless channel is in a busy state, after the SIFS time, the fourth station 140 transmits the CTS2 frame.

In step S26, the fourth station 140 receives a data frame.

In step S27, the fourth station 140 which receives the data frame transmits an ACK frame after the SIFS time.

The fourth station 140, according to another embodiment of the present invention, senses a state of a wireless channel, and if the second station 120 contends with the first station 110, transmits a dual CTS (that is, two CTSs) frame. Accordingly, the fourth station 140 according to an embodiment of the present invention may avoid a capture effect capable of occurring when using an RTS-CTS exchange method in order to address a hidden node issue.

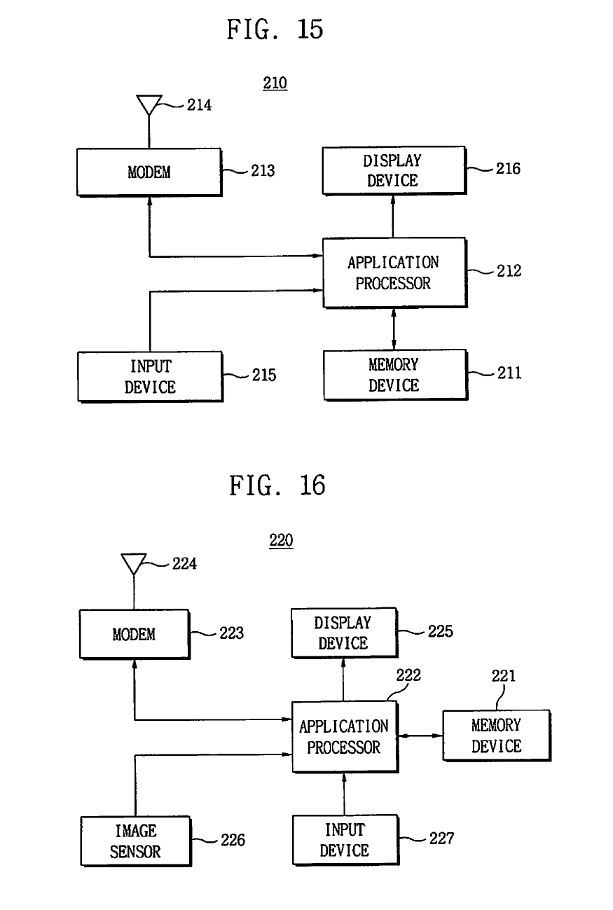

FIG. 15 is a block diagram of a computer system according to an embodiment of the present invention.

Referring to FIG.15, a computer system 210 is implemented by a Personal Computer (PC), a network server, a tablet PC, a net-book or e-reader, a smart phone, a Personal Digital Assistant (PDA), a Portable Multimedia Player (PMP), a Moving Picture Expert Group Audio Layer 3 (MP3) player, or a Moving Picture Expert Group Audio Layer 4 (MP4) player.

The computer system 210 operates based on an Android platform. According to an embodiment of the present invention, the computer system 210 is implemented by one of the first station 110, the second station 120, the third station 130, and the fourth station 140. Accordingly, the computer system 210 operates as an AP station through a tethering function or a station which accesses an AP station.

The computer system 210 includes a memory device 211, an application processor 212 including a memory controller configured to control the memory device 211, a modem 213, an antenna 214, an input device 215, and a display device 216.

The modem 213 transmits or receives a wireless signal through the antenna 214. For example, the modem 213 converts the wireless signal received through the antenna 214 into a signal capable of being processed in the application processor 212. The modem 213 includes a Long Term Evolution (LTE) transceiver, a High Speed Downlink Packet Access/Wideband Code Division Multiple Access (HSDPA/WCDMA) transceiver, and a Global System for Mobile communications (GSM) transceiver.

Accordingly, the application processor 212 processes the signal output from the modem 213, and transmits the processed signal to the display device 216. Further, the modem 213 converts the signal output from the application processor 212 into a wireless signal, and outputs the converted wireless signal to an external device through the antenna 214.

The input device 215 is a device capable of inputting a control signal for controlling an operation of the application processor 212 or data which is processed by the application processor 212, and is implemented by a pointing device such as a touch pad or a computer mouse, a keypad, or a keyboard.

FIG. 16 is a block diagram of a computer system according to another embodiment of the present invention.

Referring to FIG. 16, a computer system 220 is implemented by an image processing device, for example, a digital camera, or a mobile phone having the digital camera, a smart phone or a tablet PC in which the digital camera is mounted.

The computer system 220, including a camera function, operates based on an Android platform. According to an embodiment of the present invention, the computer system 220 is implemented by one of the first station 110, the second station 120, the third station 130, and the fourth station 140 shown in FIG. 10. Accordingly, the computer system 220 operates as an AP station through a tethering function.

The computer system 220 further includes a memory device 221 and a data processing operation of the memory device 221, for example, an application processor 222 including a memory controller configured to control a write operation or a read operation, a modem 223, an antenna 224, a display device 225, an image sensor 226, and an input device 227.

The modem 223 transmits and receives a wireless signal through the antenna 224. For example, the modem 223 converts the wireless signal received from the antenna 224 into a signal capable of being processed in the application processor 222. Accordingly, the application processor 222 processes the signal output from the modem 223, and transmits the processed signal to the display device 225.

Further, the modem 223 converts the signal output from the application processor 222 into a wireless signal, and outputs the converted wireless signal to an external device through the antenna 224.

The image sensor 226 of the computer system 220 converts an optical image into digital signals, and the converted digital signals are transmitted to the application processor 222. According to the control of the application processor 222, the converted digital signals are displayed through the display device 225, or stored in the memory device 221.

Further, the data stored in the memory device 221 is displayed through the display device 225 according to the control of the application processor 222.

The input device 227 is a device capable of inputting a control signal for controlling an operation of the application processor 222 or data which is processed by the application processor 222, and is implemented by a pointing device such as a touch pad or a computer mouse, a keypad, or a keyboard.

The WLAN system according to the present invention can increase network throughput, and avoid network unfairness caused by a capture effect.

The foregoing is illustrative of embodiments of the present invention and is not to be construed as limiting thereof. Although a few embodiments have been described, those skilled in the art will readily appreciate that many modifications are possible without materially departing from the novel teachings and advantages. Accordingly, all such modifications are intended to be included within the scope of the present invention as defined by the claims and their equivalents.

What is claimed is:

1. A Wireless Local Area Network (WLAN) system, comprising:
a first station configured to transmit a first Request To Send (RTS) frame through a wireless channel; and
a second station configured to determine whether the wireless channel is in a busy state after receiving the first RTS frame, when the wireless channel is in a busy state, transmit a first Clear To Send (CTS) frame, and after a Point Coordination Function Interframe Space (PIFS) time, transmit a second CTS frame corresponding to the first RTS frame.

2. The WLAN system according to claim 1, further comprising a third station configured to transmit a second RTS frame, when the wireless channel is in a busy state.

3. The WLAN system according to claim 2, further comprising a fourth station configured to receive the first CTS frame, and set a first Network Allocation Vector (NAV) value and an extra-NAV (E-NAV) value based on the first CTS frame.

4. The WLAN system according to claim 3, wherein the third station receives the second CTS frame, and sets a second NAV value based on the second CTS frame, and wherein the second station includes an Access Point (AP).

5. The WLAN system according to claim 3, wherein the third station preferentially accesses the second station compared to the fourth station.

6. The WLAN system according to claim 3, wherein the first station receives the second CTS frame, and transmits a data frame.

7. The WLAN system according to claim 6, wherein the second station receives the data frame, and after a Short Interframe Space (SIFS) time, transmits an Acknowledgement (ACK) frame, and wherein the E-NAV value includes time information starting from when the transmission of the ACK frame is completed.

8. The WLAN system according to claim 3, wherein each of the first station, the second station, the third station, and the fourth station uses an RTS-CTS frame exchange method, and the second station is capable of operating as an Access Point (AP) using tethering.

9. The WLAN system according to claim 2, wherein the first RTS frame and the second RTS frame include a transmission request signal for the second station.

10. A method of driving a Wireless Local Area Network (WLAN) system, comprising:
transmitting a first Request To Send (RTS) frame through a wireless channel by a first station;
determining whether the wireless channel is in a busy state;
transmitting a first Clear To Send (CTS) frame corresponding to the first RTS frame by a second station when the wireless channel is in a busy state; and
after a Point Coordination Function Interframe Space (PIFS) time, transmitting a second CTS frame by the second station.

11. The method according to claim 10, wherein transmitting the first RTS frame through the wireless channel by the first station includes transmitting a second RTS frame by a third station.

12. The method according to claim 11, wherein transmitting the first CTS frame includes setting a first Network Allocation Vector (NAV) value and an extra-NAV (E-NAV) value based on the first CTS frame by a fourth station.

13. The method according to claim 12, wherein transmitting the second CTS frame includes receiving the second CTS frame, and setting a second NAV value based on the second CTS frame, by the third station.

14. The method according to claim 11, further comprising transmitting a data frame by the first station.

15. The method according to claim 14, further comprising:
receiving the data frame by the second station; and
transmitting an ACK frame by the second station,
wherein the E-NAV value includes time information starting from when the transmission of the ACK frame is completed.

16. An apparatus for an Access Point (AP), comprising:
a station configured to:
receive a first Request To Send (RTS) frame through a wireless channel;
determine whether the wireless channel is in a busy state;
transmit a first Clear To Send (CTS) frame corresponding to the first RTS frame when the wireless channel is in a busy state; and
after a Point Coordination Function Interframe Space (PIFS) time, transmit a second CTS frame.

17. The apparatus according to claim 16, wherein the station is further configured to receive a second RTS frame.

18. The apparatus according to claim 17, wherein the first RTS frame and the second RTS frame include a transmission request signal for the station.

19. The apparatus according to claim 16, wherein the station is further configured to
receive a data frame; and
transmit an Acknowledgement (ACK) frame corresponding to the data frame.

20. The apparatus according to claim 16, wherein the wireless channel is in an idle state during the PIFS time.
